(19) United States
(12) Patent Application Publication
(10) Pub. No.: US 2024/0045165 A1
(43) Pub. Date: Feb. 8, 2024

(54) CABLE INSTALLATION APPARATUS COMPRISING CLAMPING FORCE CONTROL SYSTEM

(71) Applicant: FREMCO A/S, Frederikshavn (DK)

(72) Inventor: Hans Jacob MØLLER, Aalborg (DK)

(73) Assignee: FREMCO A/S, Frederikshavn (DK)

(21) Appl. No.: 18/257,929

(22) PCT Filed: Dec. 13, 2021
(86) PCT No.: PCT/EP2021/085450

§ 371 Date: Jun. 16, 2023

(30) Foreign Application Priority Data
Dec. 17, 2020 (DK) PA202070846

(51) Int. Cl. G02B 6/54; G02B 6/52; B65H 51/14; B65H 51/16

(52) U.S. Cl. CPC G02B 6/54; G02B 6/52; B65H 51/14; B65H 51/16; B65H 2701/32

(57) ABSTRACT

An apparatus including a blowing chamber having a cable inlet, a cable outlet, and a fluid inlet, wherein the cable outlet is configured to be connected to the duct. A pushing drive, a first conveyer part and a second conveyer part, wherein the conveyer parts are arranged at opposing sides of a cable guidance space and wherein one or both conveyer parts are configured to be driven by the pushing drive—and thereby induce a driving force onto a part of the cable arranged in the cable guidance space, wherein one or both of the first and second conveyer part is configured to be moved towards and away from the cable guidance space. A clamping force control that controls the clamping force applied onto the cable by the conveyer parts according to a first clamping setting while the driving force is applied onto the cable.

The present disclosure relates to an apparatus for installing a cable and a method of installing a cable.

### BACKGROUND

The need of installation of cables such as optical fibre cables for data communication has rapidly increased over the years to be able to follow the technological development and increased data communication over the internet and/or internal networks due to e.g. increase in video streaming, online computer gaming, data mining, but also generally to comply with an increased need/wish of being able to facilitate a proper data communication and provide a good data communication infrastructure.

Hence, the need of apparatuses for installation of such optical fiber/fibre cables into ducts has increased. In order to be able to provide a more efficient and/or cost efficient installation of such cables, the development of such apparatuses is ongoing.

WO 2018/090043 discloses a transmission line installation system including a transmission line conveying apparatus that operates to install a transmission line such as a fiber/fibre optic cable within a duct/conduit by advancing the transmission line through the conduit. The apparatus comprises different means in order to control and provide the installation of the cable, which comprises tractor devices a “hold down system”, and an air supply system. Local controllers are used.

Patent documents U.S. Pat. No. 8,074,968 and EP1914577 also discloses solutions for transmission line installation systems.

The present disclosure may e.g. provide a solution that enables a user friendly apparatus where the risk that undesired situations may occur during installation of a cable may be reduced. Additionally or alternatively, the present disclosure may e.g. provide a solution where the chance of a successful and/or more gentle installation of a cable in a duct/conduit may be increased.

### SUMMARY

The present disclosure relates in a first aspect to an apparatus for installing a cable, such as an optical fibre/fiber cable, into a duct, with the assistance of a fluid. within the duct. The apparatus comprises a blowing chamber comprising a cable inlet and a cable outlet and a fluid inlet for receiving a supply of pressurized fluid, wherein the cable outlet is configured to be connected to the duct. The apparatus moreover comprises a pushing drive unit. Additionally, the apparatus comprises a first conveyer part and a second conveyer part, wherein said conveyer parts are arranged at opposing sides of a cable guidance space and wherein one or both conveyer parts is/are configured to be driven by the pushing drive unit of the apparatus and thereby induce a driving force onto a part of the cable arranged in the cable guidance space. One or both of the first and second conveyer part is configured to be moved towards and away from the cable guidance space. The apparatus comprises a clamping arrangement configured to control one or both of the first and second conveyer part, and a sensor arrangement for providing one or more sensor input. The apparatus comprises a clamping force control system comprising one or more controllers. The clamping force control system may be configured to control the clamping arrangement based on said sensor input, so as to control the clamping force applied onto the cable by the conveyer parts according to a first clamping setting while the driving force is applied onto the cable.

The present disclosure provides a solution which may be more safe to use as the clamping force control unit provides a control of the clamping force applied onto the cable to be installed in the duct according to a selected clamping setting. This may be provided according to a selected regulation setting such as a threshold value, and hence help to provide that the cable, such as an optical fibre cable is not overloaded during installation. For example, optical fibre cables may, if clamped too hard during installation, be damaged or at least perform less optimal. The present disclosure provides a solution where it may be more easy to assure, and in certain aspects also document, that the cable is not damaged or overloaded during installation by too high clamping forces applied by the apparatus.

The present disclosure may additionally or alternatively help to provide a solution that is more user friendly as the skills/experience of the user operating the machine may be less significant for assuring a proper installation of the cable.

The present disclosure may also provide a solution that enables a faster regulation of the clamping force, e.g. by means of a feed back regulation loop, and hence the risk of providing a too large clamping force that may damage parts, such as optical fibres, of the cable may be reduced.

The clamping arrangement may in aspects of the present disclosure be controlled by the clamping force control system to automatically induce a desired clamping force based on a received/selected clamping force setting comprising the first clamping threshold such as reference/code for such a clamping threshold.

The clamping setting(s) may relate to a determined desired magnitude of a clamping force to be applied onto the cable in the cable guidance space by the conveyer part. However, the setting may be a value not directly defining a clamping force, but instead define a torque value, a current value or merely just a value within a range which indicates or is representative for a desired clamping force magnitude.

The sensor input may generally, in one or more aspects of the present disclosure, comprise clamping force sensor input. Such clamping force sensor input may e.g. comprise information from a torque measurement, a current consumption measurement value or the like and/or other parameters that may provide an indication of the applied clamping force to the cable. The sensor input may additionally or alternatively be provided from a force measurement sensor such as a strain gauge sensor arrangement configured to provide an output representative of the pressure with which the conveying part(s) presses on/clamps the cable and/or the like.

In one or more aspects of the present disclosure, the sensor input may comprise input representative of cable installation speed and/or movement speed of the conveyer part(s). This may in some aspects comprise one or more of a speed measurement sensor such as an encoder or optical reader or speed readings or settings from or related to the pushing drive unit, a force sensor or the like. One or more of these may provide input that relates to/are indicative of a slip between a drive device and the cable.

The clamping arrangement may in one or more aspects of the present disclosure be configured to enable that the drive device(s) may be displaced towards and away from the cable guidance space.

In one or more aspects of the present disclosure, the clamping arrangement comprises at least one clamping drive unit comprising an electric motor, such as an electric servo motor, configured to be controlled by the clamping force control system.

The present inventor has seen that an electric motor, such as an electric servo motor, may provide an advantageous drive for enabling a good control and regulation of the clamping force over time according to sensor input and/or when the regulation set point/clamping setting is updated.

For example, a servo motor may comprise a servo motor driver comprising a data processor, regulation software and (when in operation) predetermined, available regulation parameters such as monitored current consumption, torque measurements or estimates/calculations and/or the like that may enable advantageous clamping force regulation implementation. Also, such a servo motor comprising a servo motor driver may enable distribution of computing tasks as such servo motors may comprise regulation control loops/features that may be used for implementing control of the clamping arrangement.

In one or more aspects of the present disclosure, the clamping force control system may be configured to control the clamping arrangement, such as said clamping drive unit, to move one or both of the first and second conveyer part towards and away from the cable guidance space so as to control the applied clamping force, based on said clamping setting and said one or more sensor input.

This may provide a solution where e.g. improved control of the clamping force applied to the cable may be obtained. This may possibly in particular be obtained in case an electric motor such as an electric servo motor is used for moving one or both of the first and second conveyer part towards and away from the cable guidance space.

Controlling the position of the conveyer part(s) relative to the cable guidance space by means of a controller and based on sensor input in order to control the clamping force applied onto the cable by the conveyer parts according to a clamping setting may provide a mechanically simple solution, yet enabling enhanced control and fast regulation possibilities.

Alternatively, in other aspects of the present disclosure, the clamping arrangement may comprise an adjustable, mechanical spring system that may be adjusted/pre tensioned by a motor or the like to be set to different clamping settings by the controller(s).

In one or more aspects of the present disclosure, the clamping force control system may be configured to control the clamping arrangement to apply a higher clamping force onto the cable if predefined criteria is complied with. For example, in some aspects, the clamping force control system may be configured to control the clamping arrangement to apply a second, higher clamping setting that exceeds the first clamping setting.

Providing that the apparatus automatically applies a higher clamping force to the cable only if detected to be needed and/or considered potentially beneficial may provide a more safe solution. For example, in many situations, it may not be needed to provide a high clamping force onto the cable, as the fluid flow from the blowing chamber drags and/or lifts the cable in the tube. This, combined with a relatively low clamping pressure/force may in many situations help to provide a sufficient movement of the cable to the outlet of the duct. Operating with a low “default” first clamping setting that is only increased if detected needed by the control system according to the present circumstances during installation may e.g. induce a more safe installation of the cable with reduced risk of damaging the cable.

Additionally or alternatively, a safe control of the cable installation may be provided as e.g. temporary “force” spikes acting on the cable sleeve caused by e.g. unevenness on the cable surface may be handled in an automatic manner without overloading the cable with respect to the applied clamping force.

In one or more aspects of the present disclosure, the second, higher clamping setting may be above the first clamping setting and below or substantially correspond to a maximum clamping setting THRmax.

In one or more aspects of the present disclosure, the higher clamping setting may be configured to be set based on the presently applied clamping setting, such as to be a predefined percentage or value above the presently applied clamping setting. This my e.g. be determined/calculated by a control system of the apparatus.

In one or more aspects of the present disclosure, the clamping force control system may be configured to increase the applied clamping setting, such as gradually increase the applied clamping setting, until a maximum clamping setting is reached.

In one or more aspects of the present disclosure, said predefined criteria may comprise a detection and/or estimation of slippage between the jacket of the cable and at least one of the conveyer parts, such as wherein the second, higher clamping setting is selected if the slippage is detected to be above a slippage threshold.

This may help to increase the change of a succeeding cable installation in a more safe and controlled way.

Hence, the clamping force control system may in embodiments of the present disclosure control the clamping arrangement to apply a higher clamping force onto the cable if a slippage between the jacket of the cable and at least one of the conveyer parts is detected.

If slippage is detected, the clamping force may be increased in order to obtain an enhanced frictional grip onto the cable. This may be combined with or subsequent to a pressure increase where the pressure of the fluid in the blowing chamber is increased to increase the fluid drag force inside the duct.

For example, in aspects of the present disclosure, said predefined criteria may be based and/or comprise sensor input such as a detected movement speed of the cable to be installed (e.g. based on an encoder or similar) and the movement speed of one or both conveyer parts and/or derivatives thereof.

Some slippage may be allowed, at least if the applied clamping force is rather low, as this may not damage the cable sleeve. However extensive slippage between the jacket of the cable may influent negatively on the ability to install the cable in the duct, and hence, the clamping force may be increased by the clamping force control system if extensive slippage is detected. In some aspects of the present disclosure, the moment a slippage is detected, the clamping force control system may induce the second higher clamping setting. In other aspects of the present disclosure, a certain slippage may be allowed e.g. for a certain amount of time and/or a certain slippage per installed cable length may be allowed before increasing the clamping setting. For example, if slippage is detected over a longer time period and/or the slippage increases from a lower slippage to a higher slippage (e.g. by that an estimated or measured difference between cable movement speed and conveyer part speed increases to above a certain level) the clamping force control system may induce the second higher clamping setting.

In one or more aspects of the present disclosure, said first lower clamping setting, such as an initial clamping setting, may be configured to be at least 20%, such as at least 30%, for example at least 40% below a predefined maximum clamping setting for the cable, such as a predefined maximum rated clamping force for the cable. In one or more aspects of the present disclosure, said first lower clamping setting, such as an initial clamping setting, may be configured to be between 20% and 90%, such as between 30% and 70%, such as between 40% and 60%, below a predefined maximum clamping setting for the cable. This may help to obtain a more safe installation of the cable in the duct where the risk of damaging the cable is reduced. For a large part of cable installation tasks to be conducted, a low clamping force may be sufficient, in corporation with the fluid drag and the induced drive force. Hence, initially starting significantly below the determined maximum clamping force may appear to be sufficient in many situations and e.g. also be more gentle to the cable sleeve. Also, in case sudden force peaks arises during the installation e.g. to foreign object between the cable and conveyer part(s) or due to cable sleeve unevenness, such force peaks may be of no concern. Also, user friendliness is increased as a human user may not need to remember to assure that the initially applied clamping force is below the max. allowed clamping force. This may be taken care of by the clamping force control system automatically.

In one or more aspects of the present disclosure, said second, higher clamping setting may be at least 70%, such as at least 85%, such as at least 95% of a predefined maximum clamping setting for the cable. In case a clamping force according to the maximum clamping setting is reached and e.g. slippage is still detected, the apparatus may stop the cable installation process.

The maximum clamping setting may e.g. be an calculated or stored value represented in a data storage of the control system.

In one or more aspects of the present disclosure, said apparatus may comprise a data storage comprising information of one or more selectable clamping settings.

The different, predefined clamping settings may comprise one or more stored lower clamping settings, and/or one or more higher and/or a one or more maximum clamping settings. These may be selected by the clamping force control system and a software program code.

Additionally or alternatively, the new clamping setting may be selected/defined based on of the present clamping force setting. For example if a slippage is detected, a new higher clamping setting is provide by adding a percentage such as 5%, 10% or 20% to the present clamping force setting, thereby providing a selectable clamping setting.

In one or more aspects of the present disclosure, said clamping force control system may be configured to switch between selectable clamping settings, and/or to calculate a higher clamping setting, if predefined criteria is complied with, such as based on sensor input.

In one or more aspects of the present disclosure, said apparatus comprises a user interface, and wherein the user interface enables direct and/or indirect selection of a clamping setting between a plurality of selectable clamping settings.

This may help to provide a solution which is more user friendly and/or which may reduce the risk of applying an undesired high clamping force to the cable.

A direct selection of a clamping setting may provide that a user may e.g. select a “low clamping setting” indication in the user interface.

An indirect selection may comprise that a user merely selects a cable type, such as based on manufacturer information, cable category information, cable diameter information and/or the like that is presented by the user interface. The control system may hence have clamp settings such as an initial clamping setting and/or a maximum clamp setting stored that is associated with the respective selectable cable type, and when a user provides the selection, the associated clamping setting(s) is/are used during the installation of the cable by the clamping force control system in order to control the clamping force applied.

In one or more aspects of the present disclosure, the clamping settings may be associated to different cable types represented in the data storage, and wherein one or more of the clamping settings are configured to be automatically selected and/or calculated based on a selected cable type to be installed by means of the apparatus. This may provide that the system is more user friendly and/or safe to use where the risk of user errors and/or overloads on the cable by inducing a normal force/clamping force that may damage the cable, may be reduced.

This selection may e.g. be provided when a user selects a cable type to be installed by means of the user interface. Hence, when a user selects a cable diameter, a cable product name and/or the like by means of the user interface, which may be pre-entered in the apparatus, then the control system of the system automatically applies a first clamping setting associated with the cable selection.

In one or more aspects of the present disclosure, said increase of clamping force to exceed a first clamping force setting may be configured to be provided by the clamping force control system while the driving force is applied onto the cable and during installation of the cable into the duct.

In one or more aspects of the present disclosure, the clamping force control system may comprise a first controller comprising a first data processor, and a second controller comprising a second data processor,
wherein the first controller is configured to communicate clamping settings to the second controller based on one or more predefined criteria, and
wherein the second controller is configured to control the clamping arrangement according to the communicated clamping setting and based on said sensor input while the driving force is applied onto the cable.

This may e.g. help to provide a cost efficient solution and/or a solution where control of the clamping forces applied is distributed between controllers. It may also help to provide a solution that may be more cost efficient and/or adapted to the used components. The second controller may e.g in some aspects of the present disclosure comprise a servo motor driver or the like comprising regulation circuitry. Such regulation circuitry may need rather few instructions, such as merely a clamping setting, in order to be able to induce the desired clamping force. Hence, by e.g. communicating a new clamping setting to the servo motor driver may result in that the driver automatically provides a clamping force according to the new, updated setting, e.g. to induce a higher clamping force.

In one or more aspects of the present disclosure, the clamping force control system, such as said second controller, is configured to control the clamping force applied onto the cable by the conveyer parts according to the clamping setting(s) by means of a feedback control loop, such as a proportional, integral and/or derivative regulation control loop, based on sensor input such as sensor input representative of the present clamping force acting on the cable and/or sensor input representative of a slippage between the cable jacket and a conveyer part.

The feedback control loop may, in case it is based on sensor input representative of the present clamping force acting on the cable, help to provide a solution where sudden force peaks may be handled swift and effectively by the clamping force control system and be more gentle to the cable. Hence, in case a sudden force peak is detected, the control system may temporarily reduce the applied clamping force according to the clamping setting, and when the force peak disappears again, if it disappears, the controller automatically adjusts accordingly during the installation of the cable.

In one or more aspects of the present disclosure, the clamping force control system, may be configured to control the clamping force applied onto the cable by the conveyer parts according to a plurality of different, changing settings during a cable installation after the cable has entered the duct inlet and before the cable exits the outlet of the duct. This may in some aspects be provided by means of the second controller. The plurality of different, changing settings may be provided by means of the first controller based on sensor input.

In one or more aspects of the present disclosure, the first clamping setting may comprise an initial clamping setting representing an initial, lower clamping force to be induced upon startup of the installation of the cable into the duct.

It is generally understood that in one or more aspects of the present disclosure, the clamping setting(s) according to which the clamping force control system is configured to control the clamping arrangement is/are predetermined clamping settings values/set points stored in a data storage and/or configured to be determined according to a predefined clamping setting algorithm executed by a controller of the apparatus.

The initial clamping setting may be so low that a very limited clamping setting is provided, and the clamping control system may automatically adjust the setting according to the predefined criteria such as by means of slippage detection.

In one or more aspects of the present disclosure, the clamping force control system may be configured to control the clamping arrangement to apply a lower clamping force onto the cable, according to a lower clamping setting, if predefined criteria is complied with during installation of the cable into the duct.

In one or more aspects of the present disclosure, a controller of the apparatus, such as the control system, may be configured to control the pushing drive unit to reduce the velocity of which the cable is introduced into the duct by at least 30%, such as at least 50%, e.g. at least 75%, but not stop the pushing drive unit, when the applied clamping setting reaches a predefined level, such as a maximum clamping setting.

In one or more aspects of the present disclosure, said velocity reduction may be configured to be provided if a slippage between the jacket of the cable and at least one of the conveyer parts is detected, based on sensor input, to be above a certain amount.

The present disclosure moreover relates to a Method of installing a cable such as an optical fibre cable, into a duct, the method comprising the steps of:
providing an apparatus, the apparatus comprising:
   a blowing chamber comprising a cable inlet and a cable outlet and a fluid inlet for receiving a supply of pressurized fluid,
   a pushing drive unit,
   a first conveyer part and a second conveyer part, wherein said conveyer parts are arranged at opposing sides of a cable guidance space and wherein one or both conveyer parts are configured to be driven by the pushing drive unit and thereby induce a driving force onto a part of the cable arranged in the cable guidance space, wherein one or both of the first and second conveyer part is configured to be moved towards and away from the cable guidance space,
   a clamping arrangement configured to control one or both of the first and second conveyer part,
   a sensor arrangement for providing one or more sensor input,
   a clamping force control system comprising one or more controllers,
said method further comprising the steps of
   connecting the duct to the cable outlet to allow fluid to enter from the blowing chamber and into the duct,
   providing one or more data inputs, and wherein one or more initial clamping settings for an initial clamping force to be applied to the cable by means of the first and second conveyer part is provided based on said one or more data inputs,
   arranging the cable in the installation space,
   providing a fluid flow into the duct through the blowing chamber, and
   starting the pushing drive unit to induce the driving force onto the cable,
wherein the clamping force control system controls the clamping arrangement to induce the initial clamping force on the cable in the cable guidance space by means of the first conveyer part and the second conveyer part, and
wherein the clamping force control system increases the clamping force applied onto the cable in the cable guidance space based on said sensor input if predetermined criteria is complied with.

This method may e.g. provide one or more of the above mentioned advantages. Additionally or alternatively, it may provide a user friendly method of installing a cable in a duct where errors may be reduced.

In one or more aspects of the method, said one or more initial parameter settings, such as an initial clamping setting, is configured to be at least 30%, for example at least 40%, such as at least 60% below a predefined maximum clamping setting for the cable, such as a predefined maximum rated clamping force for the cable.

In one or more aspects of the method, the clamping force control system may increase the clamping force applied onto the cable in the cable guidance space based on said sensor input if predetermined criteria is complied with during installation of the cable into the duct.

In one or more aspects of the method, the clamping force control system may increase the clamping force applied onto the cable in accordance with calculated and/or stored, clamping settings during installation of the cable into the duct.

In one or more aspects of the method, the clamping force control system gradually increases the clamping force applied onto the cable during installation of the cable into the duct if predetermined criteria is complied with during installation of the cable into the duct, such as from the initial clamping setting and towards a predefined maximum clamping setting for the cable.

In one or more aspects of the method, the clamping force control system controls the clamping arrangement to provide an increase in applied clamping force if a slippage between the jacket of the cable and at least one of the conveyer parts is detected based on said sensor input.

In one or more aspects of the method, said sensor input comprises information of the cable movement speed and/or movement speed of one or both conveyer parts and/or derivatives thereof.

For example force measurements, such as changes in forces during installation of the cable due to increased friction in the duct, an increase or decrease in flow or pressure of the fluid, an increase or decrease of speed of the drive device(s) torque measurements, speed measurements and/or deriatives thereof may be used and compared to determine if a slippage between the jacket of the cable and at least one of the conveyer parts are present and/or increased or decreased.

In one or more aspects of the method, said one or more data inputs are provided by a human user by means of a user interface, such as a user interface of the apparatus.

In one or more aspects of the method, said one or more data inputs may be provided by means of cable selection sensor/reader input such as RFID sensor input obtained by means of a reader such as a RFID sensor reader of the apparatus. The sensor input may be configured to be directly or indirectly representative of information, such as the dimension, such as diameter, of the cable and/or duct. This sensor input may in some embodiments comprise a cable identification enabling a control system havening a register of cables, bushings or the like to identify the cable to be installed and appropriate settings based thereon. The input may also or alternatively comprise dimension information, rated clamping force information and/or the like. The reader input may originate from a reading from tags placed on bushings and/or on a cable to be installed.

In one or more aspects of the method, the providing of one or more data inputs results in a selection of a cable type to be installed in the duct, and wherein a control system of the apparatus suggests the one or more initial clamping settings based on the selected cable type.

In one or more aspects of the method, the suggested one or more initial parameter settings comprises predefined setting(s) stored in a data storage of the apparatus and/or is calculated by a controller based on predefined values stored in a data storage of the apparatus.

In one or more aspects of the method, said provided apparatus may be an apparatus according to any of the previously described aspects and/or wherein the apparatus is configured to operate according to one or more of the previously described aspects.

In a further aspect of the present disclosure, the present disclosure relates to an apparatus for installing a cable, such as an optical fibre/fiber cable, into a duct, with the assistance of a fluid within the duct. The apparatus comprises a blowing chamber comprising a cable inlet and a cable outlet and a fluid inlet for receiving a supply of pressurized fluid, wherein the cable outlet is configured to be connected to the duct. The apparatus moreover comprises a pushing drive unit. Additionally, the apparatus comprises a first conveyer part and a second conveyer part, wherein said conveyer parts are arranged at opposing sides of a cable guidance space and wherein one or both conveyer parts is/are configured to be driven by the pushing drive unit of the apparatus and thereby induce a driving force onto a part of the cable arranged in the cable guidance space. One or both of the first and second conveyer part is configured to be moved towards and away from the cable guidance space. The apparatus comprises a clamping arrangement configured to control one or both of the first and second conveyer part, and a sensor arrangement for providing one or more sensor input. The apparatus comprises a clamping force control system comprising one or more controllers. The clamping force control system is configured to control the clamping arrangement so that a first lower clamping setting is applied while the driving force is applied onto the cable, and the clamping force control system may be configured to control the clamping arrangement to increase the clamping force applied onto the cable so that the clamping force exceeds the first lower clamping setting if predefined criteria is complied with during installation of the cable into the duct.

The increase of clamping force according to the further aspect may in aspects of the present disclosure be based on sensor input such as sensor input indicating a slippage between the cable jacket and a drive device.

It is generally understood that in one or more aspects of the present disclosure, one or more of the previously described aspects may be applied to the further aspect described above.

### FIGURES

Aspects of the present disclosure will be described in the following with reference to the figures in which:

FIG. 1: Illustrates an apparatus for installing a cable according to embodiments of the present disclosure,

FIG. 2: Illustrates an apparatus for installing a cable according to further embodiments of the present disclosure,

FIG. 3: illustrates a clamping force control system according to embodiments of the present disclosure,

FIG. 4: illustrates a flow chart relating to clamping force control according to embodiments of the present disclosure,

FIG. 5a-5b: illustrates applied clamping force Fc and detected slippage according to embodimetns of the present disclosure

FIG. 6a-6b: illustrates several increases in clamping force setting and applied clamping force during an installation process, and detected slippage, according to embodiments of the present disclosure

FIG. 7a-7b: illustrates applied clamping force Fc and detected slippage according to further embodiments of the present disclosure, and

FIG. 8a-8b: illustrates applied clamping force Fc and detected slippage according to further embodiments of the present disclosure, where an initiation procedure is applied by a clamping force control system.

### DETAILED DESCRIPTION

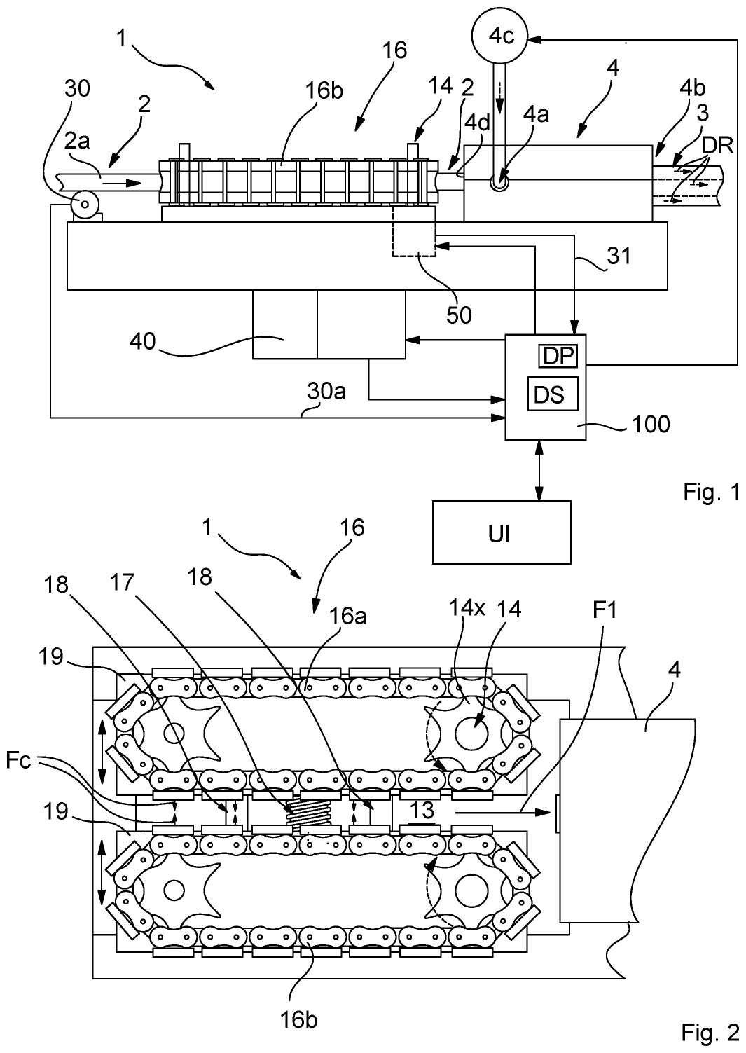

FIGS. 1 and 2 schematically illustrates an apparatus 1 for installing a cable 2, such as an optical fibre/fiber cable, also called a fiber optic cable, into a duct/conduit 3 according to embodiments of the present disclosure.

This is provided with the assistance of a fluid drag. The fluid drag is provided from a blowing chamber 4 of the apparatus. The blowing chamber 4 comprises a fluid inlet 4a for receiving a pressurized fluid such as a gas or a liquid such as water. The fluid exits the chamber 4 through the conduit/duct 3 at the fluid outlet 4b of the blowing chamber 4, and hence provides a fluid flow that assists to provide a fluid drag DR and/or lift onto the cable onto the cable 2 inside the duct 3. If the fluid is a gas, it may preferably be pressurized air.

The cable 2 may be an optical fiber cable comprising one or a plurality of optical fibers extending inside the cable sleeve 2a. The apparatus may be configured to install cables of different types, such as cables with different diameters, cables having different resistance to clamping forces, cables comprising only one, two or ten optical fibers therein or cables comprising e.g. more than 20, more than 40 or more than 60 optical fibers extending inside the common sleeve 2b. These cables may also have different stiffness and/or be made from different materials with respect to the sleeve material and/or insulation material or barriers inside the sleeve.

In one or more embodiments of the present disclosure, the apparatus 1 may be suitable for installation of cables in a duct/conduit that is longer than 200 meters, such as longer than 800 meters, such as longer than 1500 meters. The conduit 3 may hence e.g. be between 200 meters and 8000 meters in length, such as between 500 meters and 5000 meters, such as between 900 metes and 3000 meters in length.

The fluid outlet 4b hence also acts as the cable outlet and the outlet 4b may hence in embodiments of the present disclosure be configured to be connected to the duct 3 at the inlet end of the duct in a substantially fluid tight manner, such as by means of a gasket arrangement providing a fluid tight connection to the duct, such as the outer surface of the duct. Different sizes of ducts 3 may in embodiments of the present disclosure be connected to the blowing chamber outlet by switching between different sizes of gaskets and/or bushings.

A controllable fluid compression unit 4c is connected to the fluid inlet 4a in order to provide pressurized fluid into the blowing chamber 4. The compression unit 4c and/or a valve arrangement (not illustrated) may in embodiments of the present disclosure be controlled by a user or a controller of a control system of the apparatus in order to adjust the magnitude of the fluid flow and hence the fluid drag DR acting on the cable inside the tube. The fluid drag DR may in embodiments of the present disclosure be increased, e.g. gradually by a user or a controller comprising a computer processor executing software code, during installation of the cable, in order to maintain a sufficient fluid drag.

The fluid compression unit 4c, such as a compressor, may either be considered as a part of the apparatus 1 or be an external part of the apparatus 1 mainly considered as a source of pressurized fluid.

The blowing chamber (4) also comprises a cable inlet 4d for receiving a cable to be installed into the duct 3. The cable is supplied to the cable inlet 4d from a conveyer arrangement 16.

The conveyer arrangement 16 is configured to frictionally engage the cable sleeve 2a of the cable 2, and apply a motive drive force/pushing force F1 onto the cable arranged in a cable guidance space 13. For this purpose, the conveyer arrangement 16 comprises a first conveyer part 16a and a second conveyer part 16b. These conveyer parts 16a, 16b are arranged at opposing sides of the cable guidance space 13. One or both conveyer parts 16a, 16b are configured to frictionally engage with the cable and to be driven by a pushing drive unit 50 of the apparatus. Thereby, the driving force F1 is applied onto a part of the cable sleeve arranged in the cable guidance space 13, so that the cable is pushed by the conveyer arrangement 16 into the blowing chamber 4 through the inlet 4d, and therefrom into the duct 3.

The pushing drive unit 15, such as a motor, e.g. an electric motor, such as a servo motor, e.g. an electric servo motor, controls the movement of the conveyer part(s) 16a, 16b, and the drive speed of the pushing drive unit 15 determines the rotation speed of the conveyer part(s) 16a, 16b and hereby the speed with which the cable 2 is driven into the duct 3.

It is understood that only one of the conveyer part(s) 16a, 16b in embodiments of the present disclosure may be driven by the pushing drive unit 15 by means of a driven part 14, such as comprising a shaft, connected to the pushing drive unit. Hence, the other conveyer part may here be a passive conveyer part that merely is running together with the cable and not connected to the pushing drive unit be driven by this. Instead, the “active” conveyer part 16a, 16b driven by the drive unit 15 provides the pushing force onto the cable, and the other passive conveyer part merely act as a counter hold but may never the les also move by the motive force transferred to the passive conveyer part through the cable, so that the cable moves the passive conveyer part.

In other embodiments of the present disclosure, both the conveyer part 16a, 16b may be “active” conveyer parts that provides the pushing force from opposite sides of the cable 2 and cable guidance space 13. This may in some embodiments of the present disclosure be provided by means of a single pushing drive unit 15 connected by a drive force transferring arrangement to driven parts 14 that are connected to each their conveyer part 16a, 16b. In other embodiments, it may be provided by two individual pushing drive units 15 connected by a drive force transferring arrangement to each their conveyer part 16a, 16b through one or more driven parts 14 such as one or more shafts.

The driven part (14) 14 may be connected to the conveyer part 16a, 16b through one or more force transferring members 14x such as one or more drive belts, drive chains (not illustrated) and or toothed wheels 14x (see FIG. 2). Such force transferring members may enable a movement of the conveyer part(s) towards and away from a cable guidance space.

FIGS. 1-2 illustrates the conveyer parts 16a, 16b as comprising a first conveyer part type comprising a drive chain that is driven by a toothed wheel 14x (see FIG. 2) and extends around two parallel shafts arranged with a distance there between. In other embodiments of the present disclosure, the conveyer parts 16a, 16b may be of another type and may hence instead e.g. comprise drive wheels or drive belts for providing the frictional engagement with the cable. This may e.g. depend on the type of installation task and/or the type of cable to be installed into the duct 3. The apparatus may in further embodiments of the present disclosure be adapted so that different conveyer part types may be installed on the same apparatus.

In order to provide that the conveyer parts 16a, 16b can frictionally engage sufficiently with the cable 2, one or both of the first and second conveyer part 16a, 16b is configured to be moved towards and away from the cable guidance space 13. In some embodiments of the present disclosure, one of the conveyer parts 16a, 16b may be maintained in a substantially fixed position during cable installation, and may e.g. generally be maintained in a fixed position, whereas the other conveyer part may be moved towards and away from the cable guidance space in order to provide a sufficient frictional engagement with the cable. In other embodiments of the present disclosure, both the conveyer parts 16a, 16b may be movably arranged and move towards and away from the cable guidance space 13. This may e.g. help to align the cable guidance space opposite to the inlet 4d in case different cable diameters are used.

A clamping arrangement is operated/controlled in order to control a clamping force applied to the cable by the first and second conveyer part 16a, 16b. This clamping arrangement is controlled by a clamping force control system of the apparatus 1 comprising one or more controllers 40a, 100 comprising one or more data processing units DP1, DP2. This system controls the clamping force Fc, also called the “normal force” or “crushing force” applied onto the cable 2 by the conveyer parts 16a, 16b. This control may e.g. be provided according to a first clamping setting while the driving force F1 is applied onto the cable.

The clamping arrangement may comprise at least one clamping drive unit 40 comprising an electric motor, such as an electric servo motor, configured to be controlled by the clamping force control system. Hence, the clamping drive unit 40 controls a driven clamping part 17 of the clamping arrangement, such as a rack and toothed wheel arrangement, a threaded rod arrangement (as illustrated) or another (e.g linear or pivoting) actuator arrangement to move one or both of the first and second conveyer parts 16a, 16b towards and away from the cable guidance space 13 and thereby control the applied clamping force, based on a clamping setting in accordance with one or more sensor input. E.g. by reducing the distance between the parts of the conveyer parts 16a, 16b facing the cable guidance space 13, and thereby reducing the width of the cable guidance space, a larger clamping force will be applied onto the cable. Increasing the distance between the parts of the conveyer parts 16a, 16b facing the cable guidance space 13 will reduce the clamping force applied onto the cable.

Hence, the clamping arrangement is configured to control the first and/or second conveyer part 16a, 16b by controlling the position of this/these and/or by controlling a spring arrangement (see below) or the like based on input/commands from a control system 100 of the apparatus

In other embodiments of the present disclosure, the clamping arrangement may comprise a spring arrangement (not illustrating) where one or more adjustable, pre-tensioned mechanical springs presses directly or indirectly onto one or both of the conveyer parts 16a, 16b in order to provide a clamping force onto the cable. Hence, by adjusting the pre-tensioning the spring(s), the clamping force applied onto the cable may be adjusted. The clamping drive unit 40 may here adjust the pre-tensioning of the mechanical spring(s), such as coli springs or leaf springs to induce the desired clamping force.

One or more guides 18, such as linear guides, such as rods or rails, may be arranged to guide the conveyer parts 16a, 16b in the movement towards and away from the cable guidance space 13. These may help to provide an improved control of the conveyer parts 16a, 16b and the clamping force applied thereby. The driven clamping part 17 may in embodiments of the present disclosure be configured to move a base part 19 of the clamping arrangement at which the respective conveyer part 16a, 16b is arranged.

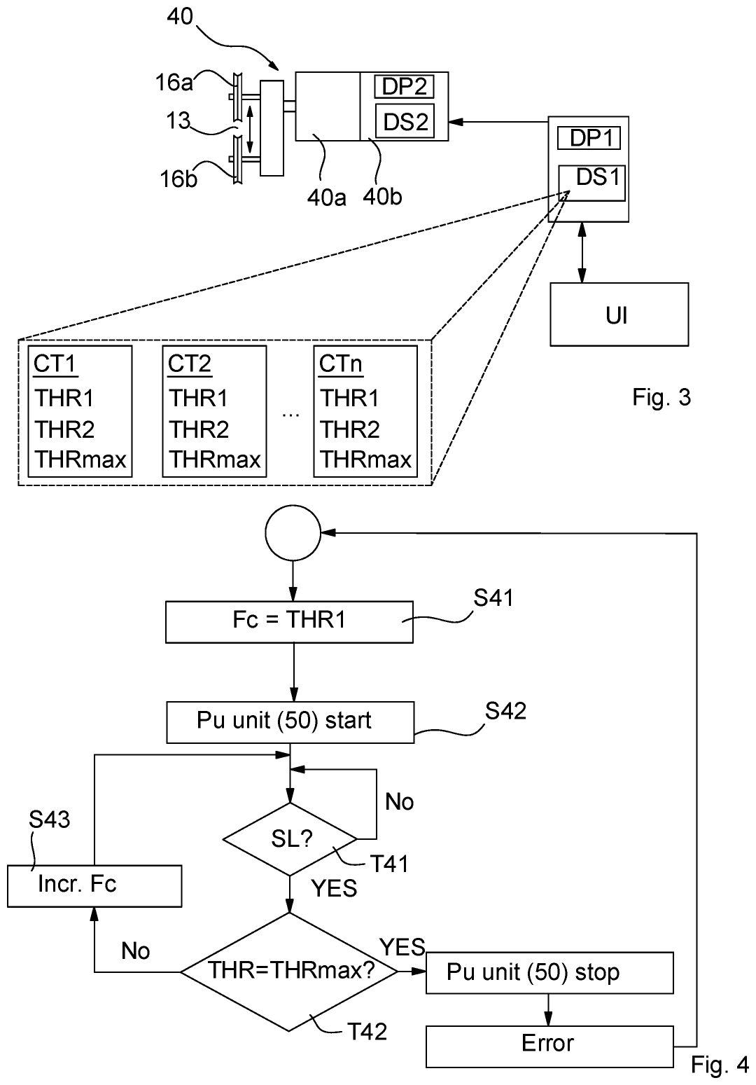

FIG. 3 illustrates schematically a more detailed, schematic view of a clamping force control system according to embodiments of the present disclosure. As mentioned above, the clamping force control system is configured to control and regulate the clamping force Fc applied onto the cable by means of the conveyer parts 16a, 16b. The clamping force control system in FIG. 3 comprises a first controller comprising a first data processor DP1. This first controller is configured to communicate clamping settings to a second controller 40a of the apparatus comprising a second data processor DP2 based on one or more predefined criteria.

The second controller is configured to control/regulate the clamping arrangement based on/according to the communicated clamping setting and based on sensor input while the driving force (F1) is applied onto the cable.

It is generally to be understood that the clamping settings THR1, THR2, THRmax may relate to a desired magnitude of a clamping force Fc to be applied onto the cable in the cable guidance space by the conveyer parts 16a, 16b. However, the clamping setting THR1, THR2, THRmax may be or comprise a value not directly defining a clamping force, but instead define a torque value, a current value or merely just a value within a range that indicates or is representative for a desired clamping force magnitude. For example, in case of a 10 bit clamping force range, 1024 may define the maximum possible clamping force that the clamping arrangement can apply, and e.g. may define 1 defines the minimum clamping force the clamping arrangement can be set to, and the clamping settings THR1, THR2, THRmax may be defined within this range. The THRmax setting may not correspond to/be defined to be the largest possible clamping force that the clamping arrangement may provide, but may instead be defined according to the cable type, and hence, be set significantly below the possible maximum clamping force that the clamping arrangement is able to provide. This may naturally vary for the different cable types CT1-CTn represented in the data storage(s) DS1/DS2.

The second controller 40a may be configured to control the clamping arrangement, such as the drive unit 40, based on sensor input. This sensor input may comprise clamping force sensor input. Such clamping force sensor input may e.g. comprise information from a torque measurement, a current consumption measurement value or the like and/or other parameters that may provide an indication of the applied clamping force to the cable. The sensor input may additionally or alternatively be provided from a force measurement sensor such as a strain gauge sensor arrangement. The clamping force sensor input may generally be input representative of the pressure with which the conveying part(s) presses on/clamps the cable and/or the like. It is understood that the sensor input may in embodiments of the present disclosure be sensor input provided from an embedded sensor arrangement of the drive unit 40 such as an electric servo motor. In certain embodiments of the present disclosure, the second controller 40a may be a part of provided by the drive unit, e.g. it may be a servo motor driver comprising drive unit 40 regulation circuitry and software adapted to provide regulation of the drive unit. For example, the drive unit may comprise a servo motor and a servo motor driver software where e.g. applied torque and/or consumed current information is made available and may be used as a regulation parameter. Hence, the servo motor driver may comprise a regulation circuitry where a torque, current value or the like may be applied as a set point and used as the clamping setting to be complied with. The servo motor driver may hence e.g. regulate the clamping force during installation of the cable so that when e.g. sudden force peaks appears, the applied clamping force Fc may be temporarily reduced. These sudden forces may e.g. be provided due to unevenness on the cable, foreign objects sticking to the cable sleeve exterior or the like entering the cable guidance space.

Generally, the second controller 40a, may comprise a feedback control loop circuitry, such as a proportional, integral and/or derivative regulation control loop (also known as a PID control), configured to regulate the clamping force applied based on the sensor input representative of the present clamping force Fc acting on the cable and a desired clamping setting THR1, while the driving force F1 is applied onto the cable.

The regulation software may be stored in the data storage DS2 of the controller 40a The first controller 100 may be configured to receive sensor input and process this input in order to determine a desired clamping setting to be utilized as a regulation parameter for the second controller based on certain criteria such as predefined one or more predefined criteria. The first controller 100 may in embodiments of the present disclosure comprise a data storage DS1 comprising a plurality of different, predefined selectable clamping settings THR1, THR2, THRmax.

In some embodiments of the present disclosure, the selectable clamping settings may be associated to different cable types CT1-CTn represented in the data storage.

Hence, one or more of the clamping settings may be selected based on a selected cable type to be installed by means of the apparatus.

In some embodiments of the present disclosure, the selection between the clamping settings for a cable type CT1-CTn may be provided based on e.g. detection and/or estimation of slippage between the jacket of the cable and at least one of the conveyer parts 16a, 16b. Hence, for example, a first initial clamping force THR1 may be provided second, higher clamping setting THR2, THRmax may be switched to/selected by the clamping force control system 100 if slippage is detected to be above a slippage threshold. Hence, the controller 100 may communicate the new higher clamping setting to the controller 40a, and the controller 40a hence controls the drive 40 in order to induce the new higher clamping force. This may reduce the slippage as a higher frictional engagement force may hereby be applied onto the cable sleeve according the new clamping setting.

In some embodiments of the present disclosure, the applied higher clamping force may be combined with a pressure and/or flow increase where the pressure and/or flow of the fluid in the blowing chamber is increased to increase the fluid drag force inside the duct. This may be obtained by a control unit (not illustrated) comprising a data processor for regulating the pressure and/or flow in the chamber 4 and duct 3. For example, the drag force provided by the fluid in the duct and acting on the cable may be controlled by means of a measurement of the flow present in e.g. the blowing chamber and/or a flow of fluid entering the blowing chamber. This measurement may be provided by means of a flow sensor or the like, or a force sensor that may act as an indication of the flow. In some embodiments, the adjustment, such as increase, in fluid flow, may naturally be provided by a control unit without regulating the clamping force.

It is understood that some slippage between cable sleeve and conveyer part 16a, 16b may be allowed, at least if the applied clamping force is rather low, as this may not damage the cable sleeve. However extensive slippage between the jacket of the cable may influent negatively on the ability to install the cable in the duct, and hence, the clamping force may be increased by the clamping force control system if extensive slippage is detected. The amount of allowed cable slip may in embodiments of the present disclosure be changed dependent on the selected clamping force setting.

In some embodiments of the present disclosure, the moment a slippage is detected, the clamping force control system may induce the second higher clamping setting. In other embodiments of the present disclosure, a certain slippage may be allowed e.g. for a certain amount of time and/or a certain slippage per installed cable length may be allowed before increasing the clamping setting. For example, if slippage is detected over a longer time period and/or the slippage increases from a lower slippage to a higher slippage (e.g. by that an estimated or measured difference between cable movement/installation speed and conveyer part speed increases to above a certain level) the clamping force control system 100, 40a may induce a second higher clamping setting.

For detecting the cable installation speed, a cable movement speed sensor 30, such as comprising an encoder device configured to be driven by the movement of the cable into the duct, may be provided. This may provide a first speed sensor input 30a to the controller 100. A second speed input 31 directly or indirectly representative of the drive speed of the conveyer part (s) 16a, 16b may be provided, e.g. from the pushing drive unit 50 (see FIG. 1) or from a selected, internal speed setting stored in the data storage DS1. Based on these inputs, the controller 100 may determine if a slippage is present and/or the amount of slippage present during cable installation, and adjust/switch/change the applied/selected clamping setting based thereon. The slippage may also be detected by detecting a speed difference between the conveyer parts 16a, 16b in case one of these is a passive counter hold part driven by the cable movement rather than the pushing drive unit 50.

Instead of or in addition to the detection/estimation of slippage, the selected clamping setting may also be adjusted based on one or more of
a detected or estimated pushing force F1 applied onto the cable or a derivative thereof)—this information may e.g. be provided by/obtained from the pushing drive unit 50 based on torque information current consumption information or the like, and/or a force sensor arrangement connected for detecting a force change between a frame of the apparatus and e.g. the base 19 (see FIG. 2) or the like.
the applied fluid pressure inside the blowing chamber 4 and/or a fluid path connected thereto,

A detected amount/length of cable installed in the tube (e.g. the clamping force may be increased if a certain length of cable is installed in the duct as slippage may in some situations occur more often later on in the installation process)

The apparatus 1 may hence be configured to initially apply a rather limited clamping force according to a first clamping setting THR1 onto the cable in the space 13 as this may in many cases be sufficient. In case slippage detection and/or or one or more other parameters fulfills certain predetermined criteria, a second, higher clamping setting THR2, THRmax configured to be above the first clamping setting THR1, and preferably also below or substantially corresponding to a maximum clamping setting THRmax, is induced by the controller 100 communicating this to the controller 40a.

It is however understood that the control provided by the controller 100 and the control provided by the controller 40a in further embodiments of the present disclosure may be integrated into the same controller, e.g. by means of the same data processor.

It is also to be understood that the pushing speed provided by the pushing drive unit 50 and determining the speed with which the cable enters the tube, in embodiments of the present disclosure may be controlled by its own control unit (not illustrated) and/or regulation circuitry such as by means of a servo motor driver software or the like separate to the controller 100. The control of the installation speed of the cable may hence also be provided by such a controller based on speed setting received from the control unit 100, or may alternatively be integrated in the same control unit such as the control unit 100.

In one or more embodiments of the present disclosure, the control system such as the controller 100, may be configured to control the pushing drive unit to reduce the velocity with which the cable is introduced into the duct by at least 30%, such as at least 50%, e.g. at least 75%, but not stop the pushing drive unit, when the applied clamping setting reaches a predefined level, such as a maximum clamping setting. A further criteria for this may in further embodiments comprise that the applied pressure and/or flow from the unit 4c is at a predefined level such as at or near a detected max flow and/or pressure limit for the fluid.

In one or more aspects of the present disclosure, said velocity reduction may be configured to be provided if a slippage between the jacket of the cable and at least one of the conveyer parts is detected, based on sensor input, to be above a certain amount.

As can be seen from FIGS. 1 and 3, the apparatus may comprise a user interface UI such as a graphical user interface (GUI). The user interface may comprise a screen for information presentation for a human user and interaction means such as a touch screen, one or more physical buttons and/or adjustment screws or the like enabling a human user to control the operation of the apparatus. In certain embodiments, the user interface may be connected by a wireless data connection to the control system of the apparatus, e.g. by means of WIFI, Bluetooth and/or the like. The user interface UI may enable direct and/or indirect selection of a stored clamping setting between the plurality of stored predefined selectable clamping settings THR1, THR2, THRmax. For example, the user may enter or select cable type information based on information presented on the screen of the user interface, and based thereon a setting for clamping force, and e.g. also installation speed, fluid pressure and/or the like may be set or suggested automatically by the apparatus.

In one or more embodiments of the present disclosure, one or more data inputs may be provided by means of cable selection sensor input (not illustrated) such as RFID sensor input obtained by means of an RFID sensor reader of the apparatus (not illustrated) and/or sensor input configured to be directly or indirectly representative of cable information such as dimension(s), such as diameter, of the cable 2 and/or duct 3, a rated max clamping force for a cable or the like. E.g. bushings or the like may in some embodiments be applied with an identifier such as an RFID, a contact set for galvanic connection and/or a micro processor (not illustrated) or the like. When changing bushing for cable and/or duct, this may be registered by a sensor of the apparatus and act as data input for the controller 100 in order to enable selection of parameter settings such as an initial and/or maximum clamping force for example the cable.

When a first cable type CT1 is selected by a user and/or by means of the above mentioned cable selection sensor input, first clamping setting values such as THR1, THRmax and/or a predefined algorithm may be automatically selected/suggested or identified for use by the control system, whereas if a second cable type CT2 is identified/selected, second clamping setting values such as THR1, THRmax and/or a predefined algorithm may be automatically selected/suggested or identified for use by the control system, e.g. by loading a value into the controller 40a and/or by adapting a regulation algotithm. The user interface UI may also in some embodiments enable or prompt a user to change/adapt the stored values for a clamping setting THR1, THR2, THRmax, and/or establishment of new cable types and settings associated therewith according to which the apparatus 1 operates if that cable type is selected or established by a user. A user may also in some embodiments enter a maximum clamping setting without this being associated with a cable type as such, and the apparatus may here regulate the clamping force during installation of a cable based thereon.

In some embodiments of the present disclosure, the first lower (initial) clamping setting THR1 may be configured/set to be at least 20%, such as at least 30%, for example at least 40% or at least 60% below a predefined maximum clamping setting THRmax for the cable 2, such as a predefined maximum rated clamping force for the cable 2.

The predefined maximum clamping setting may relate to or be representative of a rated maximum clamping force provided by the cable manufacturer or the like. Some manufacturers may define a maximum allowed, rated clamping setting on/of the cable to be installed. For example, some manufacturers may give a value or a range, such as for example a Newton/length value. E.g. a manufacturer may define a max/maximum clamping force/pressure value to be between 0-X Newton per length unit, for example as one example a value of 0-200 Newton/100 mm cable. Hence, the 200 N or a selected value slightly below this for increased safety may be used for the THRmax value in the data storage for that cable type, and the control system may assure that this THRmax value is not exceeded during installation of the cable in the duct. A user or external server may e.g. when adding a selectable type or updating a cable type in the data storage, define a max Newton/length unit for that cable. That may be the THRmax value for that cable according to which the control systems controls the clamping force during installation of that cable type, and/or the lower settings such as the initial setting may be defined/calculated based on that THRmax value.

The first lower clamping setting THR1 may e.g. be configured to be between 90% and 20%, such as between 70% and 30%, such as between 60% and 40%, below a predefined maximum clamping setting THRmax for the related cable type. The second, higher clamping setting THR2 may e.g. be at least 70%, such as at least 85%, such as at least 95% of a predefined maximum clamping setting for the related cable 2, such as merely be the max allowed clamping setting THRmax.

In some embodiments of the present disclosure, a user may e.g. merely enter a maximum clamping setting THRmax by means of the user interface, and the controller 100 may hence automatically derive/determine/suggest lower clamping settings, such as the initial clamping force settings THR1 and store these. A user may hence change these if found necessary e.g. based on experiments or experience during installation or the like. A user may also or alternatively manually enter clamping settings by means of the user interface to be used e.g. based on information provided by a cable manufacturer.

In some embodiments of the present disclosure, merely a maximum clamping setting THRmax may be represented in the data storage for a cable type, and applied clamping settings may be determined based thereon.

FIG. 4 illustrates a flow chart relating to the setting of applied clamping forces during operation of the apparatus, according to embodiments of the present disclosure. In step S41, an initial clamping setting is applied. This initial clamping setting may e.g. correspond to 50% below the maximum allowed grip, here represented by the clamping setting THR1, see e.g. above. The controller may e.g. either select the value for the initial setting if it is pre-stored in the database, or alternatively calculate the initial clamping setting based on the maximum allowable clamping setting. Then the pushing drive unit 50 is started in step S42. Prior to step S41 or S42, the fluid flow may be initiated into the duct (not illustrated in FIG. 4), but in other embodiments, this may also be provided after step S41 or S42 instead.

The clamping force control system hence in test T41 tests if predetermined criteria is complied with, such as if a certain amount of slippage (SL?) between cable and conveyer part(s) is detected. For example, if the detected slippage is above a predetermined value (e.g. determined based on a speed difference between cable and conveyer part (and/or derivatives thereof), the clamping force control system may determine that a too high slip is present and hence that the initial clamping force should be increased. Hence test T42 is initiated. Here, it is assured that the presently applied/selected clamping force is not at or above the maximum allowed clamping setting THRmax. If the present applied clamping force is below the maximum allowed clamping setting THRmax, the clamping force control system increases the applied clamping force in step S43.

This may be provided by either selecting another stored clamping setting or be calculated based on the presently applied clamping setting, such as to be a predefined percentage or value above the presently applied clamping setting. For example the applied clamping setting may be increased with between 5% and 20% compared to the present setting.

Then it is again tested (test T41) weather a too large slippage is still detected, and if it is, the clamping force may be increased again (step S43). Hence, this may provide a gradual increase in the applied clamping setting and hence applied clamping force based on the present situation, until a maximum clamping setting (THRmax) is reached (test T42). If too large slippage is detected (T41) and the maximum allowed clamping setting is already applied in this situation (T42), The controller may stop the pushing unit 50 and present or transmit an error message to the user, such as by means of the previously described user interface UI.

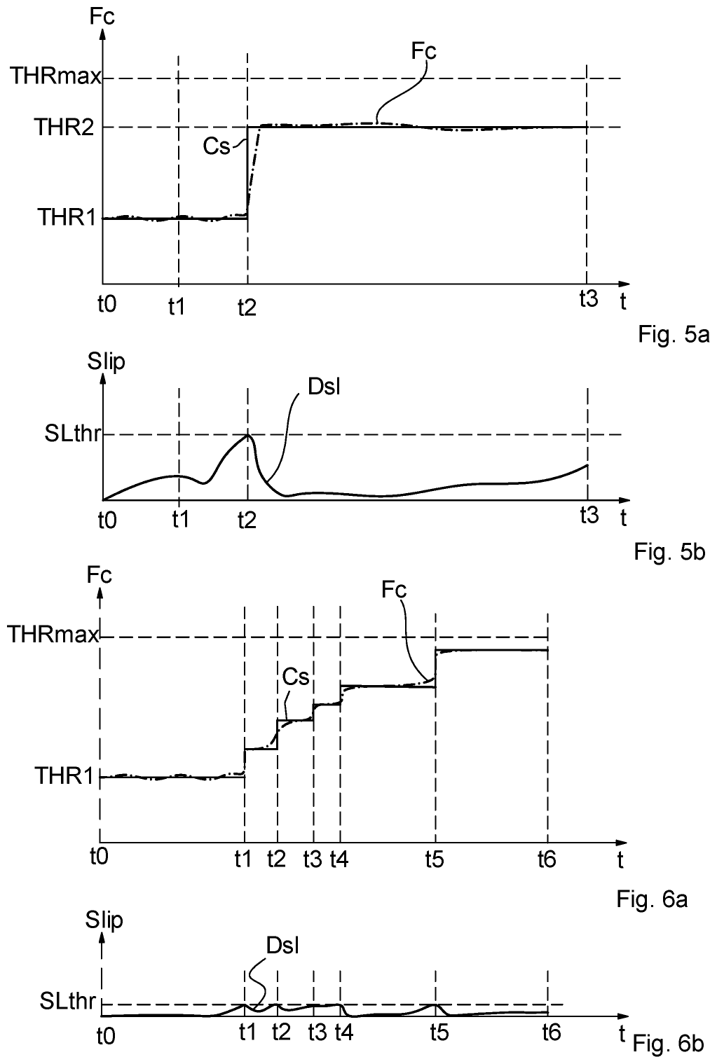

FIGS. 5a-5b illustrates the applied clamping force Fc and detected slippage as a function of time during an envisaged installation of a cable from an inlet to an outlet of the duct in the time span t0-t3. At time to, the cable 2 enters the duct the fluid flow and hence also the fluid drag in the duct is present and the pushing drive unit drives the cable into the duct, the installation process stops and is succeeded at time t3. FIG. 5a illustrates the applied clamping force Fc during the installation process, and a clamping setting Cs determined by the control system. As can be seen, the clamping setting Cs is here set to an initial low clamping setting THR1 between t0 and t2, and the clamping force control system hence controls the applied clamping force Fc to be around this setting. As can be seen in FIG. 5a, the clamping force Fc applied may vary a bit/fluctuate due to different reasons such as that the cable may be uneven or foreign objects enters between the cable sleeve and the conveyer part(s). A feedback control loop may in embodiments of the present disclosure reduce the force fluctuation by clamping force regulation based on sensor input. Such a feedback control loop may in other embodiments of the present disclosure be omitted.

FIG. 5b illustrates the detected slippage Dsl between the cable and the conveyer part(s) during the installation process. As can be seen the slip detected DSL may vary during installation as e.g. the resistance in the duct increases. At t1, it can be seen that the slippage reduces which may e.g. be provided due to that the resistance in the duct for some reason reduces and/or due to e.g. the fluid drag force from the fluid flow in the duct is increased by a control unit of the apparatus or by a human user. Hence, this may also reduce the slippage Dsl detected. At time T2, the detected slippage Dsl reaches a slippage threshold set in the control software, see e.g. test T41 in FIG. 4. This implies that as the presently applied clamping setting THR1 is well below the max allowed threshold THRmax for the cable, the controller increases the applied claiming setting, see step S43 in FIG. 4. This implies that the clamping arrangement is controlled to provide a larger clamping force Fc to the cable by the clamping force control system applying a larger clamping setting THR2, see FIG. 5a, and this causes that the slippage Dsl is reduced as a result thereof, see FIG. 5b at and just after time t2.

It appears that no further clamping force Fc increase is needed for the rest of the installation process between time t2 and t3 in the situation of FIGS. 5a-5b, as no significant slippage was detected after the increase of the clamping setting to another, higher value THR2. That said, another regulation of e.g. a the drag force by the fluid flow in the duct may in some embodiments of the present disclosure have been provided by a drag force control system of the apparatus to increase or maintain a the drag force in the duct from t2-t3, and this may help to reduce the slippage Dsl to be maintained below the threshold SLthr.

In the case of that the slip Dsl between time t2 and t3 again for some reason reached the selected threshold SLthr (not illustrated in FIG. 5a5b) the clamping force Fc would possibly be increased yet again by providing a clamping setting between the setting THR2 and THRmax, or by applying the THRmax clamping setting.

It is understood that different slip thresholds SLthr may be implied/selected and associated to e.g. different clamping settings THR1, THR2, THRmax according to further embodiments of the present disclosure. For example, larger slippage may be accepted for lower clamping settings whereas less slippage may be accepted for higher clamping forces due to e.g. the risk of increased wear onto the cable sleeve at higher clamping forces. Also, the type of conveyer part used may influent on the selection of allowed slippage/slippage threshold and/or selected clamping setting.

FIGS. 6a-6b illustrates the applied clamping force Fc and detected slippage as a function of time during an envisaged installation of a cable from an inlet to an outlet of the duct 3 in the time span t0-t6. The principal functionality may correspond to the functionality as described in relation to FIGS. 5a-5b.

As the detected slip Dsl at the time points t1, t2, t3, t4 and t5 reaches the threshold for the allowed slippage, see FIG. 6b, the clamping force Fc applied is thus gradually increased at these time points. This increase may merely be calculated based on the max allowable clamping setting THRmax and/or the initial clamping setting THR1 by the clamping force control system. As it can be seen from FIG. 6b, the slippage is generally kept below the slippage threshold (SLthr) during the cable installation process, but relatively high clamping force is first found needed about time t5, close to the finish of the installation of the cable. Hence a significant part of the installation of the cable 2 has been provided with rather low clamping force and still, acceptable or only limited, acceptable slippage has occurred.

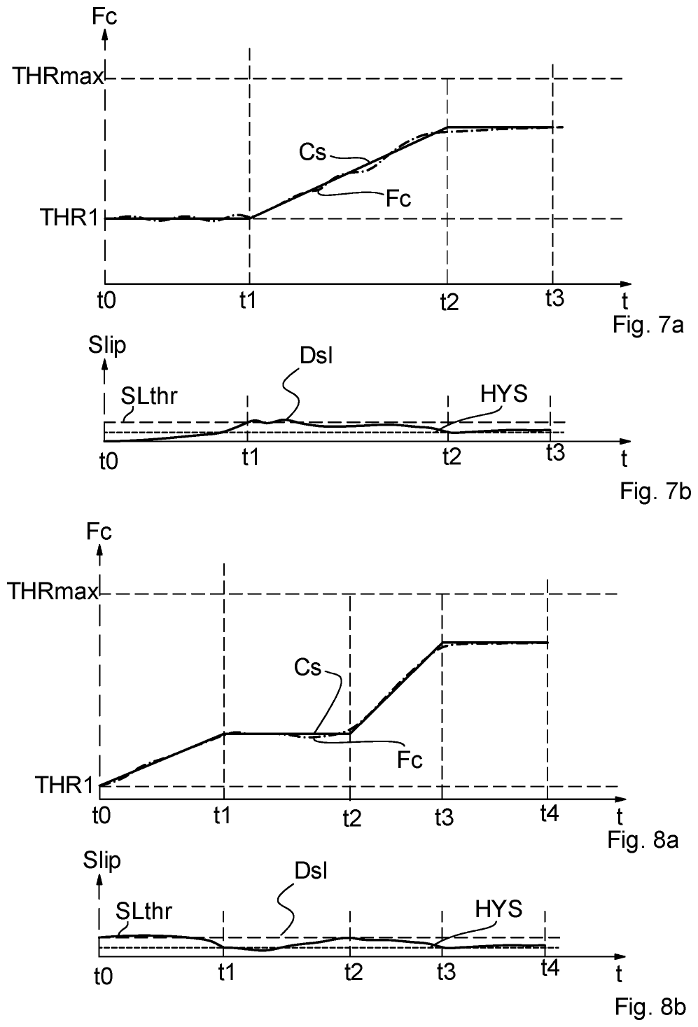

FIG. 7a-7b illustrates an embodiment of the present disclosure, during an envisaged installation of a cable, wherein a, so to say, ramp function is provided by the clamping force control system. As can be seen, relatively fast after the initiation of the installation process at to, the slippage increases. From t0-t1, the clamping setting THR1 is sufficient, but the slippage increases (see FIG. 7b) to an undesired level at about t1. Hence, the clamping force control system increases the applied clamping force by gradually increasing the clamping setting Cs until a reduced slippage between the cable sleeve and the conveyer part(s) gets below the threshold SLthr.

A hysteresis functionality HYS may in further or alternative embodiments of the present disclosure be provided in relation to e.g. the slippage so that the slippage may be allowed to be above this hysteresis value, and when the determined slippage Dsl reaches the threshold SLthr, the clamping force Fc may be increased until the slippage gets below the hysteresis HYS, in this case at the time t2. Again, it is understood that an increase of the fluid flow provided by means of the compression unit 4c providing the pressurized fluid into the duct from the blowing chamber (see e.g. FIGS. 1-2) to obtain a fluid drag inside the tube acting on the cable may also help to reduce the slippage.

In some embodiments of the present disclosure (not illustrated), the clamping force control system may also try to gradually reduce the clamping force on the cable in case no slip is detected according to some predefined criteria. For example if the slip has been absent for a certain time period or cable movement length, the clamping force control system may try to reduce the clamping force attain. That may e.g. be relevant instead e.g. the installation speed of the cable has been reduced and/or the fluid flow has been regulated in the duct. Such regulation may possibly provide that lower clamping forces may be sufficient again. That may generally be relevant, for example in case the applied clamping setting is near the max allowed clamping setting THRmax.

FIG. 8a-8b illustrates a still further embodiment of the present disclosure, wherein an initiation procedure is applied in order to provide a suitable initial clamping force based on detected cable slip. Here, a very low clamping force at clamping setting THR1 is applied which would not normally be considered sufficient or feasible for use during the installation process. However, the clamping force control system will rather fast detect a slippage between the cable and the conveyer part(s) 16a, 16b, and accordingly increase the clamping force applied by controlling the clamping arrangement. This is provided until t1 where a sufficiently low slip is detected (in this case defined by a hysteresis threshold). That slip may be substantially zero or very limited. The hysteresis is merely optional. At t1, the controller hence maintains the applied clamping force until further slip is detected at t2. Here, the slip again is above or at a predefined criteria (SLthr), and hence the clamping force is increased again until t3 where the slip is again detected as reduced sufficiently. That clamping force is then sufficient until the installation process has ended/succeeded at t4.

While the present disclosure has been described in detail in connection with only a limited number of embodiments or aspects, it should be readily understood that the present disclosure is not limited to such disclosed embodiments or aspects. Rather, the present disclosure can be modified to incorporate any number of variations, alterations, substitutions or equivalent arrangements not heretofore described, but which are commensurate in scope with the present disclosure. Additionally, while various embodiments or aspects of the present disclosure have been described, it is to be understood that aspects of the present disclosure may include only some of the described embodiments or aspects or combinations of the various embodiments or aspects. Accordingly, the present disclosure is not to be seen as limited by the foregoing description.

The present disclosure is moreover described in relation to the following items:

1. Apparatus (1) for installing a cable (2), such as an optical fibre cable, into a duct (3), with the assistance of a fluid within the duct (3), the apparatus comprising:
a blowing chamber (4) comprising a cable inlet (4d) and a cable outlet (4b) and a fluid inlet (4a) for receiving a supply of pressurized fluid, wherein the cable outlet is configured to be connected to the duct (3),
a pushing drive unit (50),
a first conveyer part (16a) and a second conveyer part (16b), wherein said conveyer parts (16a, 16b) are arranged at opposing sides of a cable guidance space (13) and wherein one or both conveyer parts (16a, 16b) are configured to be driven by the pushing drive unit (50) of the apparatus and thereby induce a driving force (F1) onto a part of the cable arranged in the cable guidance space (13), wherein one or both of the first and second conveyer part (16a, 16b) is configured to be moved towards and away from the cable guidance space (13),
a clamping arrangement (40, 40a, 17) configured to control one or both of the first and second conveyer part (16a, 16b),
a sensor arrangement for providing one or more sensor input,
a clamping force control system comprising one or more controllers (100, 40b), wherein the clamping force control system is configured to control the clamping arrangement (40, 40a, 17) based on said sensor input, such as during installation of the cable (2) into the duct (3).

2. Apparatus according to item 1, wherein the clamping arrangement comprises at least one clamping drive unit (40a, 40) comprising an electric motor, such as an electric servo motor, configured to be controlled by the clamping force control system (100, 40b).

3. Apparatus according to any of the preceding items, wherein the clamping force control system (DP1, DP2) is configured to control the clamping arrangement (40, 40a, 17), such as said clamping drive unit (40a, 40), to move one or both of the first and second conveyer part (16a, 16b) towards and away from the cable guidance space (13), such as so as to control the applied clamping force based on said clamping setting (THR1, THR2, THRmax) and said one or more sensor input while the driving force (F1) is applied onto the cable.

4. Apparatus according to any of the preceding items, wherein the clamping force control system (40b, 100) is configured to control the clamping arrangement based on said sensor input so as to control the clamping force (Fc) applied onto the cable (2) by the conveyer parts (16a, 16b) according to a first clamping setting (THR1, Cs) while the driving force (F1) is applied onto the cable.

5. Apparatus according to any of the preceding items, wherein the clamping force control system (40b, 100) is configured to control the clamping arrangement to apply a higher clamping force onto the cable (2) if predefined criteria is complied with.

In some further embodiments, in accordance with item 5 above, the clamping arrangement may be configured to apply a higher clamping force onto the cable (2) according to a second, higher clamping setting (THR2, THRmax, Cs) which exceeds a first clamping setting (THR1, Cs), if said predefined criteria is complied with.

6. Apparatus according to item 5, wherein the higher clamping setting (THR2, THRmax) is configured to be set based on the presently applied clamping setting (Cs), such as to be a predefined percentage or value above the presently applied clamping setting.

7. Apparatus according to any of the preceding items, wherein the clamping force control system (100, 40b) is configured to increase the applied clamping setting (Cs, THR1, THR2), such as gradually increase the applied clamping setting, until a maximum clamping setting (THRmax) is reached, such as based on the sensor input.

8. Apparatus according to any of items 5-7, wherein said predefined criteria comprises a detection and/or estimation of slippage between the jacket of the cable (2) and at least one of the conveyer parts (16a, 16b), such as wherein the second, higher clamping setting (THR2, THRmax, CS) is provided if the slippage is detected to be above a slippage threshold.

9. Apparatus according to any of the preceding items, wherein said first clamping setting (THR1, Cs), such as an initial clamping setting, is configured to be at least 20%, such as at least 30%, for example at least 40% below a predefined maximum clamping setting (THRmax) for the cable (2), such as a predefined maximum rated clamping force for the cable (2).

10. Apparatus according to any of the preceding items, wherein said first clamping setting (THR1), such as an initial clamping setting, is configured to be between 20% and 90%, such as between 30% and 70%, such as between 40% and 60%, below a predefined maximum clamping setting (THRmax).

11. Apparatus according to any of the preceding items, wherein said apparatus comprises a data storage (DS1, DS2) comprising information of one or more selectable clamping settings (THR1, THR2, THRmax).

12. Apparatus according to item 11, wherein said clamping force control system (100, 40a) is configured to switch between said selectable clamping settings (THR1, THR2, THRmax), and/or to calculate a higher clamping setting (Cs), if predefined criteria (T41, T42) is complied with, such as based on sensor input.

13. Apparatus according to any of the preceding items, wherein said apparatus comprises a user interface (UI), and wherein the user interface (UI) enables direct and/or indirect selection of a clamping setting between a plurality of selectable clamping settings (THR1, THR2, THRmax, Cs).

14. Apparatus according to any of items 11-13, wherein the clamping settings (THR1, THR2, THRmax) are associated to different cable types (CT1-CTn) represented in the data storage (DS1, DS2), and wherein one or more of the clamping settings are configured to be automatically selected and/or calculated based on a selected cable type to be installed by means of the apparatus.

15. Apparatus according to any of items 4-14, wherein an increase of clamping force (Fc) to exceed a first clamping force setting (THR1) is configured to be provided by the clamping force control system (100, 4b) while the driving force (F1) is applied onto the cable and during installation of the cable into the duct.

16. Apparatus according to any of the preceding items, wherein the clamping force control system (100, 4b) comprises a first controller (100) comprising a first data processor (DP1), and a second controller (40b) comprising a second data processor (DP2),
wherein the first controller (100) is configured to communicate clamping settings (THR1, THR2, THRmax) to the second controller (40b) based on one or more predefined criteria, and
wherein the second controller (40b) is configured to control the clamping arrangement according to the communicated clamping setting (THR1, THR2, THRmax) and based on said sensor input while the driving force (F1) is applied onto the cable.

17. Apparatus according to any of the preceding items, wherein the clamping force control system (100, 40b), such as said second controller (40b), is configured to control the clamping force (Fc) applied onto the cable (2) by the conveyer parts (16a, 16b) according to the clamping setting(s) (THR1, THR2, THRmax) by means of a feedback control loop, such as a proportional, integral and/or derivative regulation control loop, based on sensor input such as sensor input representative of the present clamping force (Fc) acting on the cable and/or sensor input representative of a slippage between the cable jacket (2a) and a conveyer part (16a, 16b).

18. Apparatus according to any of the preceding items, wherein the clamping force control system (100, 40b), such as said second controller (40b), is configured to control the clamping force (Fc) applied onto the cable (2) by the conveyer parts (16a, 16b) according to a plurality of different, changing settings (THR1, THR2, THRmax, Cs) during a cable installation after the cable has entered the duct (3) inlet and before the cable exits the outlet of the duct (3).

19. Apparatus according to any of the preceding items, wherein the first clamping setting (THR1, Cs) is an initial clamping setting representing an initial, lower clamping force to be induced upon startup of the installation of the cable (2) into the duct (3).

20. Apparatus according to any of the preceding items, wherein the clamping force control system (DP1, DP2) is configured to control the clamping arrangement to apply a lower clamping force onto the cable (2), according to a lower clamping setting (Cs, THR1), if predefined criteria is complied with during installation of the cable into the duct.

21. Apparatus according to any of the preceding items, wherein a controller is configured to control the pushing drive unit (50) to reduce the velocity of which the cable is introduced into the duct by at least 30%, such as at least 50%, e.g. at least 75%, but not stop the pushing drive unit, when the clamping setting reaches a predefined level, such as a maximum clamping setting (THRmax).

22. Apparatus according to item 21, wherein said velocity reduction is configured to be provided if a slippage between the jacket of the cable (2) and at least one of the conveyer parts (16a, 16b) is detected (T41, Dsl), based on sensor input, to be above a certain amount.

23. An apparatus for installing a cable, such as an optical fibre/fiber cable, into a duct, with the assistance of a fluid within the duct, wherein the apparatus comprises:
a blowing chamber comprising a cable inlet and a cable outlet and a fluid inlet for receiving a supply of pressurized fluid, wherein the cable outlet is configured to be connected to the duct,
a pushing drive unit.

a first conveyer part and a second conveyer part, wherein said conveyer parts are arranged at opposing sides of a cable guidance space and wherein one or both conveyer parts is/are configured to be driven by the pushing drive unit of the apparatus and thereby induce a driving force onto a part of the cable arranged in the cable guidance space, wherein one or both of the first and second conveyer part is configured to be moved towards and away from the cable guidance space
a clamping arrangement configured to control one or both of the first and second conveyer part,
a sensor arrangement for providing one or more sensor input,
a clamping force control system comprising one or more controllers,

wherein the clamping force control system is configured to control the clamping arrangement so that a first lower clamping setting is applied while the driving force is applied onto the cable, such as wherein the clamping force control system may be configured to control the clamping arrangement to increase the clamping force applied onto the cable so that the clamping force exceeds the first lower clamping setting if predefined criteria is complied with during the installation of the cable into the duct.

24. An apparatus for installing a cable according to item 23, wherein the apparatus is an apparatus according to any of items 1-22.

25. Method of installing a cable (2) such as an optical fibre cable, into a duct (3), the method comprising the steps of:
providing an apparatus (1), the apparatus comprising:
   a blowing chamber (4) comprising a cable inlet (4d) and a cable outlet (4b) and a fluid inlet (4a) for receiving a supply of pressurized fluid,
   a pushing drive unit (50),
   a first conveyer part (16a) and a second conveyer part (16b), wherein said conveyer parts (16a, 16b) are arranged at opposing sides of a cable guidance space (13) and wherein one or both conveyer parts (16a, 16b) are configured to be driven by the pushing drive unit (50) of the apparatus and thereby induce a driving force (F1) onto a part of the cable arranged in the cable guidance space (13), wherein one or both of the first and second conveyer part (16a, 16b) is configured to be moved towards and away from the cable guidance space (13),
   a clamping arrangement (17, 40, 40a) configured to control one or both of the first and second conveyer part (16a, 16b),
   a sensor arrangement for providing one or more sensor input,
   a clamping force control system comprising one or more controllers (100, 40b),
said method further comprising the steps of
   connecting the duct (3) to the cable outlet (4b) to allow fluid to enter from the blowing chamber and into the duct,
   providing one or more data inputs, and wherein one or more initial clamping settings (THR1, Cs) for an initial clamping force (Fc) to be applied to the cable (2) by means of the first and second conveyer part (16a, 16b) is provided based on said one or more data inputs,
   arranging the cable in the installation space (13)
   providing (4c) a fluid flow into the duct (3) through the blowing chamber (4), and
   starting the pushing drive unit (50) to induce the driving force (F1) onto the cable (2),
wherein the clamping force control system (100, 40b) controls the clamping arrangement (17, 40a, 40) to induce the initial clamping force (Fc) on the cable in the cable guidance space (13) by means of the first conveyer part (16a) and the second conveyer part (16b), and
wherein the clamping force control system controls the clamping arrangement (40, 40a, 17) based on said sensor input during installation of the cable (2) into the duct (3).

26. Method according to item 25, wherein the clamping force control system controls the clamping force (Fc) applied onto the cable (2) by the conveyer parts (16a, 16b) according to a first clamping setting (THR1, Cs) while the driving force (F1) is applied onto the cable.

27. Method according to item 25 or 26, wherein the clamping force control system (40b, 100) controls the clamping arrangement to apply a higher clamping force onto the cable (2), such as according to a second, higher clamping setting (THR2, THRmax) which exceeds the first clamping setting (THR1), if predefined criteria is complied with.

28. Method according to item 27, wherein said predefined criteria comprises a detection and/or estimation of slippage between the jacket of the cable (2) and at least one of the conveyer parts (16a, 16b).

29. Method according to any of items 25-28, wherein the clamping force control system (40b, 100) controls the clamping arrangement to apply a higher clamping force onto the cable (2) if a slippage between the jacket of the cable (2) and at least one of the conveyer parts (16a, 16b) is detected.

30. Method according to item 28 or 29, wherein the second, higher clamping setting (THR2, THRmax) is provided/applied if the slippage is detected to be above a slippage threshold (SLthr).

31. Method according to any of items 25-230, wherein the apparatus is an apparatus according to any of items 1-25.

1. An apparatus for installing a cable into a duct, with the assistance of a fluid within the duct, the apparatus comprising:
a blowing chamber having a cable inlet, a cable outlet, and a fluid inlet for receiving a supply of pressurized fluid, wherein the cable outlet is configured to be connected to the duct;
a pushing drive;
a first conveyer part nd a second conveyer part, wherein the first conveyer part and the second conveyer part are arranged at opposing sides of a cable guidance space and wherein one or both of the first conveyer part and the second conveyer part are configured to be driven by the pushing drive of the apparatus and thereby induce a driving force (F1) onto a part of the cable arranged in the cable guidance space, wherein one or both of the first conveyer part and the second conveyer part is configured to be moved towards and away from the cable guidance space;
a clamping arrangement configured to control one or both of the first conveyer part and the second conveyer part;
a sensor arrangement for providing one or more sensor input;
a clamping force control comprising one or more controllers, wherein the clamping force control is configured to control the clamping arrangement based on the one or more sensor input, so as to control a clamping force (Fc) applied onto the cable by the first conveyer part and the second conveyer part according to a first clamping setting while the driving force (F1) is applied onto the cable.

2. The apparatus according to claim 1, wherein the clamping arrangement comprises at least one clamping drive unit comprising an electric motor configured to be controlled by the clamping force control.

3. The apparatus according to claim 1, wherein the clamping force control system is configured to control the clamping arrangement to move one or both of the first conveyer part and the second conveyer part towards and away from the cable guidance space so as to control the applied clamping force, based on said clamping setting and the one or more sensor input.

4. The apparatus according to claim 1, wherein the clamping force control system is configured to control the clamping arrangement to apply a higher clamping force onto the cable, such as according to a second, higher clamping setting which exceeds the first clamping setting, if predefined criteria is complied with.

5. The apparatus according to claim 4, wherein the predefined criteria comprises a detection and/or estimation of slippage between a jacket of the cable and at least one of the first conveyer part and the second conveyer part.

6. (canceled)

7. The apparatus according to claim 1, wherein the clamping force control is configured to increase an applied clamping setting until a maximum clamping setting is reached.

8. The apparatus according to claim 1, wherein the first clamping setting is configured to be at least 20% below a predefined maximum clamping setting for the cable.

9. The apparatus according to claim 1, wherein the clamping force control system is configured to switch between selectable clamping settings, and/or to calculate a higher clamping setting, if predefined criteria is complied with.

10. The apparatus according to claim 1, wherein the apparatus comprises a data storage comprising information of one or more selectable clamping settings.

11. (canceled)

12. The apparatus according to claim 1, wherein the apparatus comprises a user interface, and wherein the user interface enables direct and/or indirect selection of a clamping setting between a plurality of selectable clamping settings.

13. (canceled)

14. The apparatus according to claim 4, wherein an increase of clamping force (Fc) to exceed the first clamping force setting is configured to be provided by the clamping force control system while the driving force (F1) is applied onto the cable and during installation of the cable into the duct.

15. The apparatus according to claim 1, wherein the clamping force control system comprises a first controller comprising a first data processor, and a second controller comprising a second data processor,
wherein the first controller is configured to communicate clamping settings to the second controller based on one or more predefined criteria, and
wherein the second controller is configured to control the clamping arrangement according to the communicated clamping setting and based on the one or more sensor input while the driving force (F1) is applied onto the cable.

16. The apparatus-according to claim 1, wherein the clamping force control system, is configured to control the clamping force (Fc) applied onto the cable by the first conveyer part and the second conveyer part according to clamping setting(s) by a feedback control loop, based on sensor input such as sensor input representative of the present clamping force (Fc) acting on the cable and/or sensor input representative of a slippage between a cable jacket and either the first conveyer part of the second conveyer part.

17. The apparatus according to claim 1, wherein the clamping force control is configured to control a clamping force (Fc) applied onto the cable by the first conveyer part and the second conveyer part parts according to a plurality of different, changing settings during a cable installation after the cable has entered the duct inlet and before the cable exits an outlet of the duct.

18. The apparatus according to claim 1, wherein the first clamping setting is an initial clamping setting representing an initial, lower clamping force to be induced upon startup of installation of the cable into the duct.

19. The apparatus according to claim 1, wherein the clamping force control system is configured to control the clamping arrangement to apply a lower clamping force onto the cable, according to a lower clamping setting, if predefined criteria is complied with during installation of the cable into the duct.

20. The apparatus according to claim 1, wherein a controller is configured to control the pushing drive to reduce the velocity of which the cable is introduced into the duct by at least 30% but not stop the pushing drive unit, when the clamping setting reaches a predefined level.

21. The apparatus according to claim 20, wherein the reduction in velocity is configured to be provided if a slippage between a jacket of the cable and at least one of the first conveyer part and the second conveyer part part is detected, based on sensor input, to be above a certain amount.

22. The apparatus according to claim 1, wherein the first clamping setting is configured to be at least 30% below a predefined maximum clamping setting for the cable.

23. A method of installing a cable into a duct, the method comprising:
providing an apparatus, the apparatus comprising:
a blowing chamber having a cable inlet, a cable outlet, and a fluid inlet for receiving a supply of pressurized fluid;
a pushing drive;
a first conveyer part and a second conveyer part, wherein the first conveyer part and the second conveyer part are arranged at opposing sides of a cable guidance space and wherein one or both of the first conveyer part and the second conveyer part are configured to be driven by the pushing drive of the apparatus and thereby induce a driving force (F1) onto a part of the cable arranged in the cable guidance space, wherein one or both of the first conveyer part and the second conveyer part is configured to be moved towards and away from the cable guidance space;
a clamping arrangement configured to control one or both of the first conveyer part and the second conveyer part;
a sensor arrangement for providing one or more sensor input;
a clamping force control system comprising one or more controllers;
the method further comprising:
connecting the duct to the cable outlet to allow fluid to enter from the blowing chamber and into the duct;
providing one or more data inputs, and wherein one or more initial clamping settings for an initial clamping force (Fc) to be applied to the cable by the first conveyer part and the second conveyer part is provided based on the one or more data inputs,
arranging the cable in the installation space;
providing a fluid flow into the duct through the blowing chamber; and
starting the pushing drive to induce the driving force (F1) onto the cable;
wherein the clamping force control controls the clamping arrangement to induce the initial clamping force (Fc) on the cable in the cable guidance space by the first conveyer part and the second conveyer part; and
wherein the clamping force control increases the clamping force applied onto the cable in the cable guidance space based on the one or more sensor input if predetermined criteria is complied with.

24-37. (canceled)
